(19) United States
(12) Patent Application Publication
(10) Pub. No.: US 2024/0094588 A1
(43) Pub. Date: Mar. 21, 2024

(54) METHOD FOR PRODUCING AN ELECTROCHROMIC DEVICE, ELECTROCHROMIC DEVICE, AND INSULATING GLAZING

(71) Applicant: SAINT-GOBAIN GLASS FRANCE, COURBEVOIE (FR)

(72) Inventor: Sebastian SARRACH, MÜNCHEN (DE)

(21) Appl. No.: 18/264,204

(22) PCT Filed: Jan. 25, 2022
(86) PCT No.: PCT/EP2022/051565

§ 371 Date: Aug. 3, 2023

(30) Foreign Application Priority Data
Feb. 4, 2021 (EP) 21155168.4

(51) Int. Cl. G02F 1/153; E06B 3/67; E06B 9/24; G02F 1/1335; G02F 1/1343

(52) U.S. Cl. CPC G02F 1/153; E06B 3/6722; E06B 9/24; G02F 1/133509; G02F 1/13439; E06B 2009/2464; G02F 2203/055; G02F 2203/11

(57) ABSTRACT

A method for producing an electrochromic device includes the following procedures in the following order: providing a substrate, applying a first electrically conductive layer, applying at least one active layer, introducing first non-interconnected recesses in a specified first pattern, applying a second electrically conductive layer, and connecting a specified proportion of the first recesses by a laser cut through all previously applied layers.

The invention relates to a method for producing an electrochromic device, an electrochromic device, and an insulating glazing.

Glazings with switchable or controllable optical properties are one type of modern, active glazings. With such glazings, for example, the transmittance of light can be actively influenced as a function of an applied electrical voltage. The user can, for example, switch from a transparent to a non-transparent state of the glazing to prevent vision into the room from the outside. With other glazings, the transmittance can be infinitely adjusted, for example, to regulate the entry of solar energy into a room. Thus, undesirable heating of buildings or vehicle interiors is avoided and the energy consumption or CO 2 emission caused by air conditioning systems is reduced. Consequently, active glazings are used not only for the visually appealing designing of façades and pleasant lighting in interiors, but are also advantageous from an energy and ecology standpoint.

The known switchable or controllable glazings are based on various technical principles. Electrochromic glazings are known, for example, from US 2012/0026573 A1 and WO 2012/007334 A1 and WO 2017/102900 A1.

Electrochromic glazings include at least one electrochemically active layer that is capable of reversibly storing charges. The oxidation states in the stored and released state differ in their coloration, with one of these states being transparent. The storage reaction can be controlled via the externally applied potential difference. The basic structure of the electrochromic glazing thus comprises at least one electrochromic material, such as tungsten oxide, which makes contact with both a surface electrode and a charge source, such as an ion-conductive electrolyte. In addition, the electrochromic layer structure contains a counter electrode, which is likewise capable of reversibly storing cations and is in contact with the ion-conductive electrolyte, as well as another surface electrode, which is connected to the counter electrode. The surface electrodes are connected to an external voltage source by which the voltage applied to the active layer can be regulated. The surface electrodes are usually thin layers of electrically conductive material, often indium tin oxide (ITO). Often, at least one of the surface electrodes is applied directly on the surface of one of the individual panes of the composite glass, for example, by cathodic sputtering.

Known insulating glazings are made from at least two panes joined to one another via at least one circumferential spacer. Depending on the embodiment, the space between the two panes referred to as the glazing interior is filled with air or gas.

Beyond their basic function, insulating glazings can also contain further elements in the form of built-in components or panes with controllable additional functions. Glazings with switchable or controllable optical properties are one type of modern, active glazings. Such a glazing is known, for example, from EP 3 702 572 A1. In such glazings, for example, the transmittance of light can be actively influenced as a function of an electrical voltage applied. The user can, for example, switch from a transparent state to a non-transparent state of the glazing to prevent vision into a room from the outside.

The active glazing contains a functional element, which typically includes an active layer between two surface electrodes. The optical properties of the active layer can be changed by a voltage applied to the surface electrodes. Electrochromic functional elements are used in building construction in particular to shade large glass surfaces and to prevent prevent people inside the building from being dazzled by solar radiation. The transmittance of visible light through the electrochromic functional element can be controlled by the voltage applied to the functional element. The voltage is fed via so-called bus bars, which are usually applied on the surface electrodes and are connected to a voltage source via suitable connection cables.

EP 2 841 987 B1 discloses a method for circumferential sealing of an electrochromic element with a primary sealant.

US 2009/0284821 A1 describes a method for producing an electrochromic glazing, in which the risk of short-circuits and fault currents should be minimized.

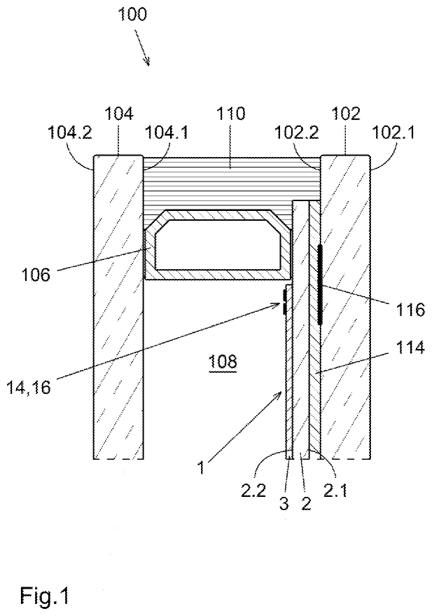

In a known insulating glazing, an insulating glazing shown FIG. 1 comprises a first pane 102 and a second pane 104. The first pane 102 has a first surface 102.1 and a second surface 102.2. The second pane 104 has a first surface 104.2 and a second surface 104.2. The first surface 104.1 of the second pane 104 and the second surface 102.2 of the first pane 102 face one another, and a spacer 106 is arranged between these surfaces. The region between the first pane 102 and the second pane 104 is provided with the seal 110 outside the spacer 106. In addition, an electrochromic device 1 comprising a substrate and an electrochromic element 3 is arranged on the second surface 102.2 of the first pane 102. The first surface 2.1 of the substrate 2 is laminated via a composite film 114 to the second side 102.2 of the first pane 102. The multilayer electrochromic element 3 is arranged on the second side 2.2 of the substrate 2. The electrochromic element 3 has two contacts designed as bus bars 14, 16. In addition, a masking strip 116 is applied on the second side of the first pane in the region of the spacer.

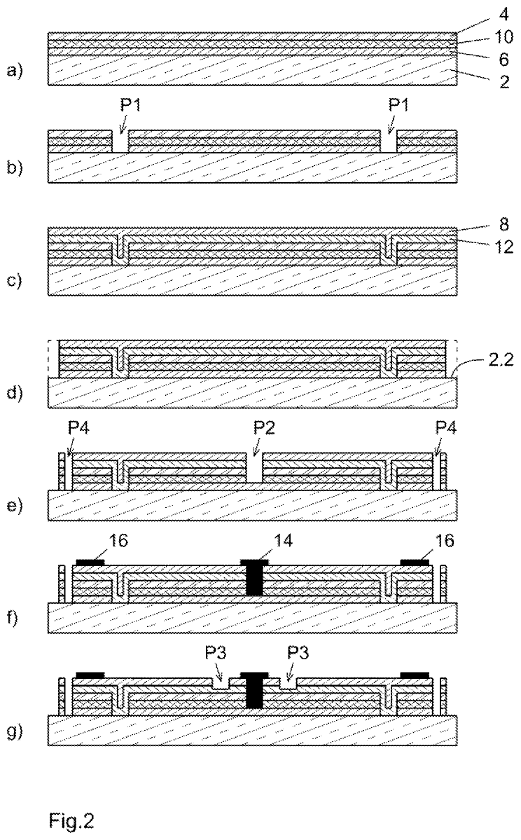

In order to produce an electrochromic functional element for a glazing or insulating glazing, various layers have to be deposited and contacts or insulations have to be applied to the layers. The known method is explained with reference to FIG. 2. A first electrically conductive layer 6 is deposited on the substrate 2, followed by an insulating layer 10 and in active layer 4. The active layer 4 includes electrochromic material. The layer stack thus produced is shown in FIG. 2a). In the subsequent step, first recesses P1 are cut, in particular by means of a laser. These recesses extend over the first electrically conductive layer 6, the first insulating layer 10, and the active layer 4 and are shown in FIG. 2b. The size of the active region of the electrochromic element 3 is fixed by the introduction of the recesses P1.

Subsequently, a second insulating layer 12 and a second electrically conductive layer 8 are deposited. The second insulating layer 12 and the second electrically conductive layer 8 extend even into the recesses P1, as shown in FIG. 2c.

FIG. 2d shows that the edges are cut to the final shape using a laser cut.

In the following step, the second and fourth recesses P2, P4 are introduced, with the fourth recess P4 cutting through all layers, the second recess P2 cutting through the layers up to and including the first insulating layer. These are shown in FIG. 2e.

FIG. 2f depicts the applied first and second bus bars 14 and 16. In FIG. 2g, the second electrically conductive layer is subsequently removed by means of the recess P3 at a specified location such that the first bus bar contacts the first conductive layer and the second bus bar contacts the second conductive layer.

A disadvantage of the above method is that the shape and size of the electrochromic device is already fixed before the beginning of the deposition process and the patterning process. This makes the production process for the electrochromic device and also for corresponding devices inflexible and the corresponding production times long, which, among other things, also increases production costs.

The object of the invention is to specify a method and a device that are improved relative to the above-mentioned disadvantages. In particular, the production process should be made more flexible.

The object of the invention is accomplished with regard to the method with the features of claim 1; with regard to the device, with the features of claim 7; and with regard to the insulating glazing, with the features of claim 10. Useful embodiments emerge from the respective subclaims.

The method according to the invention for producing an electrochromic device comprises the following steps in the following order:
a) Providing a substrate,
b) Applying a first electrically conductive layer,
c) Applying at least one active layer,
d) Introducing first non-interconnected recesses in a specified first pattern,
e) Applying a second electrically conductive layer, and
f) Connecting a specified proportion of the first recesses by means of a laser cut through all previously applied layers.

The advantage of the method according to the invention consists in that a final shape and size of the electrochromic device does not have to be determined at the beginning. The shaping patterning now does not occur until step f. The substrate and the electrically conductive layers are at least partially transparent, in particular completely transparent.

The first pattern is a pattern that extends uniformly over the entire, or substantially the entire surface of the substrate, optionally excluding, for example, an edge region of the substrate. “Substantially the entire surface” means that most of the surface, in particular at least 90% of the surface has the first pattern.

In embodiment, the method further comprises step b1) after step b) and/or step d1) after step d), wherein step b1) comprises applying a first insulating layer and step d1) comprises applying a second insulating layer. The first insulating layer is arranged between the first electrically conductive layer and the active layer, and the second insulating layer is arranged between the active layer and the second electrically conductive layer.

The first recesses are expediently arranged as grid points or dashed lines. The individual points or lines can have a recess width of 5 μm to 30 μm. A grid width or the distance between the lines can be in the range from 1 mm to 10 cm, in particular 5 mm to 5 cm. In the case of dashed lines, the individual line sections can be, for example, in a range from 100 μm to 1 mm.

In embodiment, the method further comprises applying electrical contacts, in particular in the form of a first and/or second bus bar.

The first electrically conductive layer and/or the second electrically conductive layer can, in embodiment, be directly adjacent the active layer.

The first electrically conductive layer and/or the second electrically conductive layer expediently contains or consists of a transparent conductive oxide, preferably indium tin oxide (ITO), fluorine-doped tin oxide (SnO₂:F), antimony-doped tin oxide, boron-doped zinc oxide, aluminum-doped zinc oxide, or gallium-doped zinc oxide.

Tungsten oxide or vanadium oxide, for example, can be used as the electrochromic material.

The substrate preferably contains glass, particularly preferably flat glass, float glass, quartz glass, borosilicate glass, soda lime glass or clear plastics, particularly preferably rigid clear plastics, for example, polycarbonate or polymethyl methacrylate. The substrates can be clear and transparent or also tinted or or colored.

The electrochromic device for a glazing, in particular insulating glazing, comprises a substrate and an electrochromic element.

The electrochromic element comprises a first conductive layer and a second conductive layer and an active layer arranged between the first conductive layer and the second conductive layer.

The first conductive layer and the active layer include, arranged in a first pattern, first recesses that are connected to one another in a second pattern by means of subsequently inserted fourth recesses through the first conductive layer, the active layer, and the second conductive layer.

The first pattern of first recesses (P1) extends uniformly over the entire or substantially the entire surface of the substrate. Here, “substantially the entire surface” means that most of the surface, in particular at least 90% of the surface has the first pattern. Optionally, for example, a circumferential edge region of the substrate can be left out.

The second pattern is not a regular pattern, but corresponds in particular to the final shape of the electrochromic device.

In embodiment, the first conductive layer can be arranged on a second surface of the substrate.

The recesses are expediently arranged as grid points or a dashed line.

The insulating glazing according to the invention is provided with an electrochromic device according to the invention. The insulating glazing has at least a first pane, a second pane, a spacer, and a first glazing interior between the first pane and the second pane. The electrochromic element is arranged between a second side of the first pane and a first side of the second pane. The arrangement in the insulating glazing protects the electrochromic device against environmental influences.

The first pane can form the substrate of the electrochromic device, or the first pane can be joined to the second side with the substrate by means of a composite film. In the second alternative, the substrate and the first pane form a laminated composite glass.

In a further alternative, the electrochromic device can also be connected to the second pane.

In embodiment, the first pane is an outer pane of the insulating glazing facing the building environment; and the second pane constitutes an inner pane of the insulating glazing.

In a further embodiment, the second pane and/or a third pane arranged in the glazing interior includes at least one infrared-reflecting coating. The insulating glazing can also have further coatings and/or functional elements.

Expediently, the first pane and/or the second pane contains or consists of glass, preferably flat glass, float glass, quartz glass, borosilicate glass, soda lime glass, or polymers, preferably polycarbonate or polymethyl methacrylate.

An expedient use of the glazing is as building exterior glazing or façade glazing, with the first pane facing the building environment in the installed state.

In the following, the invention is explained in greater detail, also with regard to further features and advantages, with reference to the description of exemplary embodiments and with reference to the accompanying drawings. They depict in each case schematically:

FIG. 1 insulating glazing,

FIG. 2 prior art method;

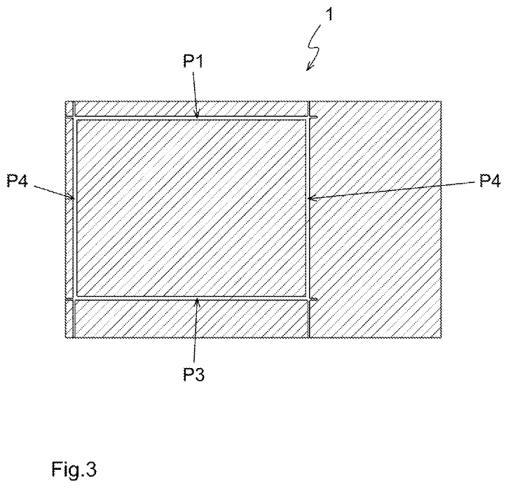

FIG. 3 top view of an electrochromic device;

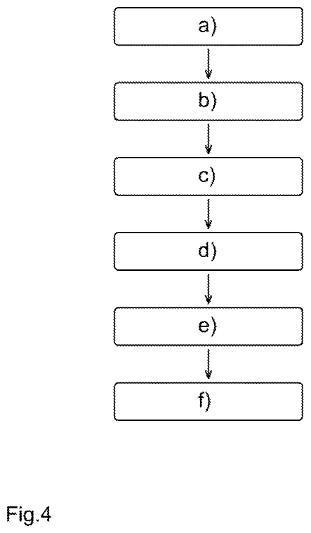

FIG. 4 method for producing an electrochromic device;

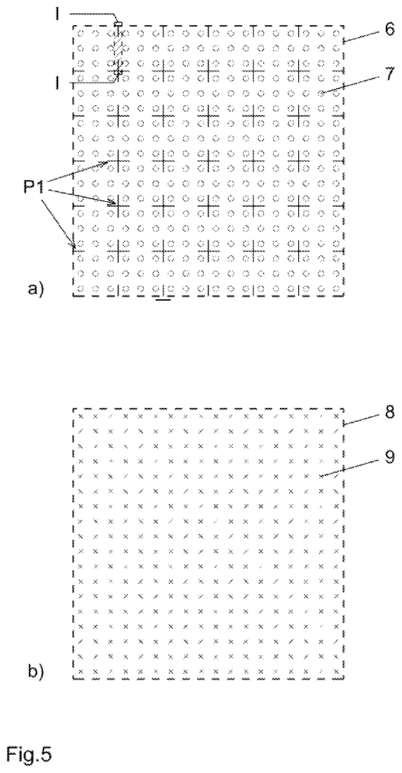

FIG. 5a,b top view of the first conductive layer of the electrochromic device after step d and of the second conductive layer of the electrochromic device after step e

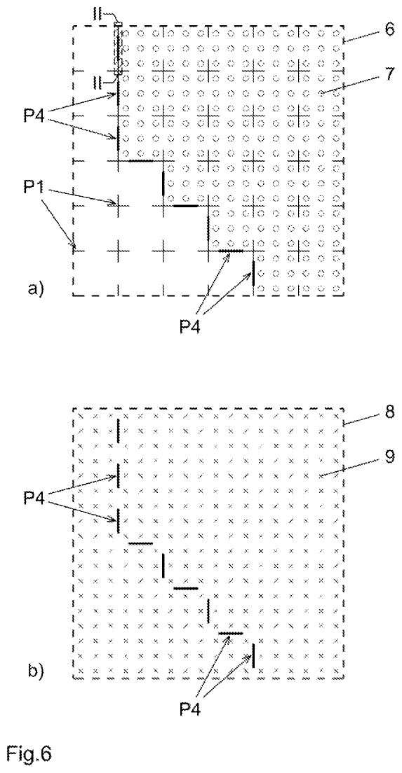

FIG. 6a,b top view of the first conductive layer of the electrochromic device after step f and of the second conductive layer of the electrochromic device after step f, and

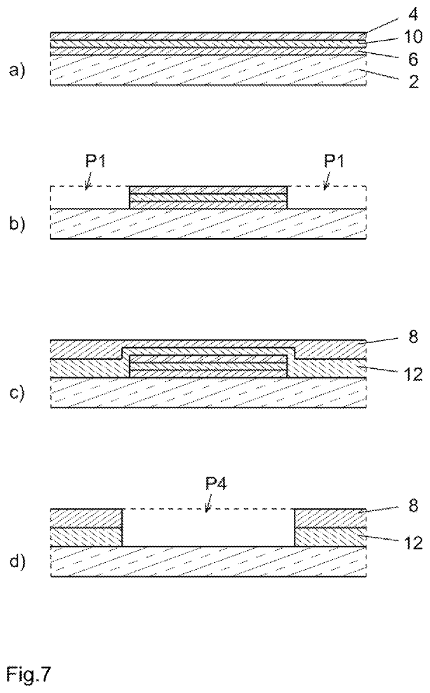

FIG. 7a-d cross-sections after steps c), d), e), and f).

FIG. 1 depicts the above-described insulating glazing. As an alternative to a conventionally produced electrochromic device as described with reference to FIG. 2, this can also have an electrochromic device according to the invention, which is described with reference to the following figures.

FIG. 3 depicts a raw substrate plate, i.e., not cut to size, with the layers deposited thereon and the first, second, third, and fourth recesses introduced.

FIG. 4 depicts the sequence of the method for producing an electrochromic device. In a first step a), a substrate 2 is provided. The substrate 2 can, in particular, be a sheet of glass or plastic. The substrate 2 is transparent. As a second step, the method includes step b), in which a first electrically conductive layer 6 is applied. The first electrically conductive layer 6 can be, in particular, ITO. In step c), at least one active layer 4 is applied on the electrically conductive layer 6. The layer sequence after step c) is also shown in FIG. 7a. The active layer 4 is the electrochromic layer. Step d) comprises introducing the first non-interconnected recesses P1 in a specified first pattern. In step d), a plurality of recesses, in particular of the same shape and size, are introduced into the layer stack. The plurality of recesses is expediently distributed uniformly, two dimensionally, over the entire surface or virtually the entire surface. A distribution of such first recesses P1 is depicted, for example, in FIG. 5a. An electrically connected first region 7 is represented in FIG. 5a by the uniform hatching over the entire surface. A cross-section I-I is depicted in FIG. 7b.

Step e) follows this patterning step with applying a second electrically conductive layer 8. Thus, the entire layer stack is already completed before the final shape of the device is defined. FIG. 5b depicts a top view of the second conductive layer 8. An electrically connected second region 9 is illustrated by the uniform hatching over the entire surface in FIG. 5b. An illustration of the cross-section is shown in FIG. 7c, depicting the same detail as 7b.

In a step f), a specified proportion of the first recesses P1 are connected to one another by means of a laser cut through all previously applied layers. The corresponding cuts introduced for the connection are shown in FIG. 6a for the first conductive layer 6; and in FIG. 6b, for the second conductive layer 8. The first region 7 in the first conductive layer 6 is now spatially delimited by the first and fourth recesses P1, P4. The second region 9 in the second conductive layer 8 is fourth recesses, is not delimited by the non-interconnected recesses P4. FIG. 7d depicts a cross-section along II, i.e., along a first recesses P1 connected by means of fourth recesses P4. The layer stack thus patterned can now be provided, if necessary, with insulation and/or contacts. Depending on the final application, the electrochromic device can now be introduced into the manufacturing process for insulating glazing.

### LIST OF REFERENCE CHARACTERS

1 electrochromic device
2 substrate
2.1 first surface
2.2 second surface
3 electrochromic element
4 active layer
6 first conductive layer
7 first region
8 second conductive layer
9 second region
10 first insulating layer
12 second insulating layer
14 first bus bar
16 second bus bar
100 insulating glazing
102 first pane
102.1 third surface
102.2 fourth surface
104 second pane
104.1 fifth surface
104.1 sixth surface
106 spacer
108 glazing interior
110 seal
112 coating
114 composite film
116 masking strip
P1 first recess
P2 second recess
P3 third recess
P4 fourth recess

1. A method for producing an electrochromic device comprising the following steps in the following order:
a) providing a substrate
b) applying a first electrically conductive layer,
c) applying at least one active layer,
d) introducing first non-interconnected recesses in a specified first pattern,
e) applying a second electrically conductive layer,
f) connecting a specified proportion of the first non-interconnected recesses by of a laser cut through all previously applied layers,
wherein the first pattern of first non-interconnected recesses extends uniformly over the entire or substantially the entire surface of the substrate.

2. The method according to claim 1, further comprising step b1) after step b) and/or d1) after step d, wherein step b1) comprises applying a first insulating layer, wherein step d1) comprises applying a second insulating layer.

3. The method according to claim 1,
wherein the first non-interconnected recesses are arranged as grid points or dashed lines.

4. The method according to claim 1, comprising
applying electrical contacts.

5. The method according to claim 1, wherein the first electrically conductive layer and/or the second electrically conductive layer are directly adjacent the active layer.

6. The method according to claim 1, wherein the first electrically conductive layer and/or the second electrically conductive layer contain or consist of a transparent conductive oxide.

7. An electrochromic device for a glazing,
comprising a substrate and an electrochromic element,
wherein the electrochromic element comprises a first conductive layer and a second conductive layer and an active layer arranged between the first conductive layer and the second conductive layer,
wherein the first conductive layer and the active layer comprise first recesses arranged in a first pattern and the first pattern of first recesses extends uniformly over an entire or substantially the entire surface of the substrate,
wherein the first recesses are connected to one another in a second pattern by subsequently inserted fourth recesses through the first conductive layer, the active layer, and the second conductive layer.

8. The electrochromic device according to claim 7, wherein the first conductive layer is arranged on a second surface of the substrate.

9. The electrochromic device according to claim 7, wherein the first recesses are arranged as grid points or as a dashed line.

10. An insulating glazing with an electrochromic device according to claim 7, wherein the insulating glazing has at least a first pane, a second pane, a spacer, and a first glazing interior between the first pane and the second paned,
wherein the electrochromic element is arranged between a second side of the first pane and a first side of the second pane.

11. The insulating glazing according to claim 10, wherein the first pane forms the substrate of the electrochromic device or the first pane is joined with the second side to the substrate by a composite film.

12. The insulating glazing according to claim 10, wherein the first pane constitutes an outer pane of the insulating glazing facing the environment of the building and the second pane constitutes an inner pane of the insulating glazing.

13. The insulating glazing according to claim 10, wherein the second pane and/or a third pane arranged in the glazing interior include at least one infrared-reflecting coating.

14. The insulating glazing according to claim 10, wherein the first pane and/or the second pane contain or consist of glass or a polymer.

15. A method comprising providing an insulating glazing according to claim 10 as a building exterior glazing or façade glazing, wherein the first pane faces the building environment in an installed state.

16. The method according to claim 4, wherein the electrical contacts include first and/or second bus bar.

17. The method according to claim 6, wherein the transparent conductive oxide is indium tin oxide (ITO), fluorine-doped tin oxide (SnO₂:F), antimony-doped tin oxide, boron-doped zinc oxide, aluminum-doped zinc oxide, or gallium-doped zinc oxide.

18. The electrochromic device according to claim 7, wherein the glazing is an insulating glazing.

19. The insulating glazing according to claim 14, wherein the glass is flat glass, float glass, quartz glass, borosilicate glass, soda lime glass, and the polymer is polycarbonate or polymethyl methacrylate.
